(19) United States
(12) Patent Application Publication
(10) Pub. No.: US 2025/0348062 A1
(43) Pub. Date: Nov. 13, 2025

(54) MACHINE LEARNING APPROACH FOR DESCRIPTIVE, PREDICTIVE, ANDPRESCRIPTIVE FACILITY OPERATIONS

(71) Applicant: Chevron U.S.A. Inc., San Ramon, CA (US)

(72) Inventors: Amitkumar C. Jain, Katy, TX (US); Ivan R. Berry, Houston, TX (US); Peter A. Richardel, Houston, TX (US); Sakthivel Kandasamy, Houston, TX (US); Qiong Zhang, Katy, TX (US); Carlos M. Yengle, Houston, TX (US); Olamide Shadiya-Oluwadairo, Houston, TX (US); Seth T. Taylor, Fullerton, CA (US); Nilesh M. Shah, Houston, TX (US)

(21) Appl. No.: 18/862,445

(22) PCT Filed: May 5, 2023
(86) PCT No.: PCT/US2023/021116

§ 371 Date: Nov. 1, 2024

Related U.S. Application Data
(60) Provisional application No. 63/338,563, filed on May 5, 2022.

(51) Int. Cl. G05B 19/418

(52) U.S. Cl. CPC G05B 19/41885; G05B 2219/33002; G05B 2219/42163

(57) ABSTRACT

A digital twin of a facility defines relationships between different components of the facility and a system of record for the facility. Information from different monitoring systems for the facility are related to events by the digital twin of the facility. Historical operation information for the facility is used to train a machine learning model. The trained machine learning model facilitates operations at the facility by providing descriptive information, predictive information, and/or prescriptive information on the operations at the facility.

### CROSS-REFERENCE TO RELATED APPLICATIONS

The present application claims the benefit of U.S. Provisional Application No. 63/338,563, entitled “MACHINE LEARNING APPROACH FOR DESCRIPTIVE, PREDICTIVE, AND PRESCRIPTIVE FACILITY OPERATIONS,” which was filed on May 5, 2022, the entirety of which is hereby incorporated herein by reference.

### FIELD

The present disclosure relates generally to the field of facilitating facility operations using a machine learning approach.

### BACKGROUND

Different monitoring systems may be used to monitor and troubleshoot operations at a facility. Data collected by different monitoring systems may be siloed in different databases, and use of such data to facilitate facility operations may be difficult and time consuming.

### SUMMARY

This disclosure relates to facilitating facility operations. Historical operation information and/or other information for a facility may be obtained. The historical operation information for the facility may be obtained based on a digital twin of the facility and/or other information. The digital twin of the facility may define relationships between components of the facility. A machine learning model may be trained using the historical operation information and/or other information for the facility. The trained machine learning model may facilitate one or more operations at the facility by outputting descriptive information, predictive information, prescriptive information, and/or other information on the operation(s) at the facility. The trained machine learning model may be stored in a storage medium.

Facility scenario information and/or other information may be obtained. The facility scenario information may define a scenario of a given operation at the facility. The facility scenario information may be input into the trained machine learning model. The trained machine learning model may output the descriptive information, the predictive information, the prescriptive information, and/or other information on the given operation at the facility.

A system for facilitating facility operations may include one or more electronic storage, one or more processors and/or other components. The electronic storage may store information relating to a facility, historical operation information, information relating to historical operation at a facility, information relating to a digital twin of the facility, information relating to components of the facility, information relating to relationships between components of the facility, information relating to a machine learning model, information relating to training of the machine learning model, information relating to usage of the machine learning model, and/or other information.

The processor(s) may be configured by machine-readable instructions. Executing the machine-readable instructions may cause the processor(s) to facilitate facility operations. The machine-readable instructions may include one or more computer program components. The computer program components may include one or more of a historical operation component, a train component, a storage component, a scenario component, a facility operation component, and/or other computer program components.

The historical operation component may be configured to obtain historical operation information and/or other information for a facility. The historical operation information for the facility may be obtained based on a digital twin of the facility and/or other information. The digital twin of the facility may define relationships between components of the facility.

In some implementations, the digital twin may output the historical operation information for the facility based on the relationship between the components of the facility and/or other information.

In some implementations, the historical operation information for the facility may include process control information, alarm information, bypass information, safety information, operator action information and/or other information. The process control information, the alarm information, the bypass information, the safety information, the operator action information, and/or other information related to an event may be correlated for the machine learning model(s) by the digital twin.

In some implementations, the process control information, the alarm information, the bypass information, the safety information, the operator action information, and/or other information related to the event may be correlated based on a piping and instrumentation diagram, a cause and effect chart, and/or other information.

In some implementations, correlation of the process control information, the alarm information, the bypass information, the safety information, and the operator action information related to the event based on the piping and instrumentation diagram may include: generation of a graph model for the facility based on the piping and instrumentation diagram and/or other information; and the correlation of the process control information, the alarm information, the bypass information, the safety information, and the operator action information related to the event being performed based on the graph model for the facility.

In some implementations, the graph model for the facility may include nodes for physical components of the facility and control components of the facility. The graph model for the facility may include different types of edges between nodes to represent physical connection and logical connection between corresponding components of the facility. The physical connection between components of the facility may include a process line between components of the facility. The logical connection between components of the facility may include electrical connection and/or input/output connection between components of the facility.

The train component may be configured to train one or more machine learning models. The machine learning model(s) may be trained using the historical operation information for the facility and/or other information. The trained machine learning model(s) may facilitate one or more operations at the facility. The trained machine learning model(s) may facility operation(s) at the facility by outputting descriptive information, predictive information, prescriptive information, and/or other information on the operation(s) at the facility.

In some implementations, the machine learning model(s) may include one or more sequence models.

The storage component may be configured to store the trained machine learning model(s). The trained machine learning model(s) may be stored in one or more storage media.

In some implementations, the trained machine learning model may perform one or more classification tasks.

In some implementations, the trained machine learning model may perform one or more regression tasks.

The scenario component may be configured to obtain facility scenario information and/or other information. The facility scenario information may define a scenario of one or more operations at the facility.

The facility operation component may be configured to input the facility scenario information and/or other information into the trained machine learning model(s). The trained machine learning model(s) may output the descriptive information, the predictive information, and/or the prescriptive information on the operation(s) at the facility. The trained machine learning model(s) may output the descriptive information, the predictive information, and/or the prescriptive information on the scenario of operation(s) at the facility.

In some implementations, one or more automated operations at the facility may be performed based on the prescriptive information on the operation(s) at the facility and/or other information.

In some implementations, the facility operation component may be configured to provide visualization of the descriptive information, the predictive information, and/or the prescriptive information on the operation(s) at the facility. The facility operation component may be configured to provide visualization of the descriptive information, the predictive information, and/or the prescriptive information on the scenario of operation(s) at the facility.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for facilitating facility operations.

FIG. 2A illustrates an example method for facilitating facility operations.

FIG. 2B illustrates an example method for facilitating facility operations.

FIG. 3 illustrates an example process for facilitating facility operations.

FIG. 4 illustrates an example Instrumented protection layers and Operator action overview.

FIG. 5 illustrates an example graph model for a facility.

### DETAILED DESCRIPTION

The present disclosure relates to facilitating facility operations. A digital twin of a facility defines relationships between different components of the facility and a system of record for the facility. Information from different monitoring systems for the facility are related to events by the digital twin of the facility. Historical operation information for the facility is used to train a machine learning model. The trained machine learning model facilitates operations at the facility by providing descriptive information, predictive information, and/or prescriptive information on the operations at the facility.

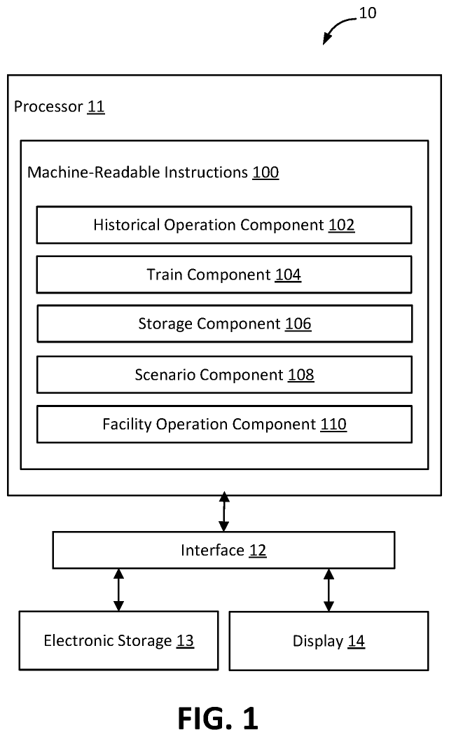

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Historical operation information and/or other information for a facility may be obtained by the processor 11. The historical operation information for the facility may be obtained based on a digital twin of the facility and/or other information. The digital twin of the facility may define relationships between components of the facility and a system of record for the facility. A machine learning model may be trained by the processor 11 using the historical operation information and/or other information for the facility. The trained machine learning model may facilitate one or more operations at the facility by outputting descriptive information, predictive information, prescriptive information, and/or other information on the operation(s) at the facility. The trained machine learning model may be stored by the processor 11 in a storage medium.

Facility scenario information and/or other information may be obtained by the processor 11. The facility scenario information may define a scenario of a given operation at the facility. The facility scenario information may be input by the processor 11 into the trained machine learning model. The trained machine learning model may output the descriptive information, the predictive information, the prescriptive information, and/or other information on the given operation at the facility.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to a facility, historical operation information, information relating to historical operation at a facility, information relating to a digital twin of the facility, information relating to components of the facility, information relating to relationships between components of the facility, information relating to a system of record for the facility, information relating to a machine learning model, information relating to training of the machine learning model, information relating to usage of the machine learning model, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present information relating to a facility, historical operation information, information relating to historical operation at a facility, information relating to a digital twin of the facility, information relating to components of the facility, information relating to relationships between components of the facility, information relating to a system of record for the facility, information relating to a machine learning model, information relating to training of the machine learning model, information relating to usage of the machine learning model, and/or other information.

A facility may refer to a place where one or more particular activities occur. A facility may include equipment to perform one or more activities. A facility may include equipment to accomplish one or more functions. For example, a facility may include an oil platform, oil rig, offshore platform, refinery, or oil and/or gas production platform to extract and/or process resources (e.g., hydrocarbon) that lie in rock formations underground. Other types of facilities are contemplated.

A process disturbance may refer to a disturbance (e.g., interruption, breakdown, deviation, impairment) of the operations at a facility. A facility may include automatic and/or manual tools to address process disturbances at the facility. For example, a facility may include process control loops to automatically responds to and/or mitigate instability in operation caused by a process disturbance. If the process disturbance is not properly addressed, process alarms may prompt operators of the facility to act. If manual actions by the operators do not address the process disturbance, other alarms may be triggered and automatic safeguard actions may be activated to partially and/or totally shutdown the facility (e.g., to prevent catastrophic failure). Such shutdown events may be costly and disruptive.

A facility may include multiple monitoring systems to monitor processes, equipment, operator actions, conditions, and/or other aspects of operations at the facility. Different layers of monitoring may be used to monitor and troubleshoot different aspects of operations at the facility. For example, a facility may include separate monitoring of process controls, alarms, bypass actions, and instrumented protective systems. Information gathered by these separate monitoring systems may be separately maintained and used separately for different purposes.

The present disclosure provides a machine learning-based tool that provides descriptive, predictive, and/or prescriptive information on facility operations. The machine learning-based tool may improve facility reliability and reduce shutdowns by connecting information from separate monitoring systems (siloed systems) to enable more efficient prioritization and decision making. Information from separate monitoring systems may be contextualized and correlated using a digital twin of the facility. The contextualization and correlation of information enable use of machine learning model for process automation and operator response to process disturbances. The machine learning model may be trained using historical operation information for the facility. The machine learning model may digitize operator knowledge/experience from the historical operation information. The machine learning model may be used to describe what is happening at the facility, predict what will happen at the facility (e.g., predict facility response), and/or prescribe action to be taken by operators. The machine learning model may be used to automate actions at the facility.

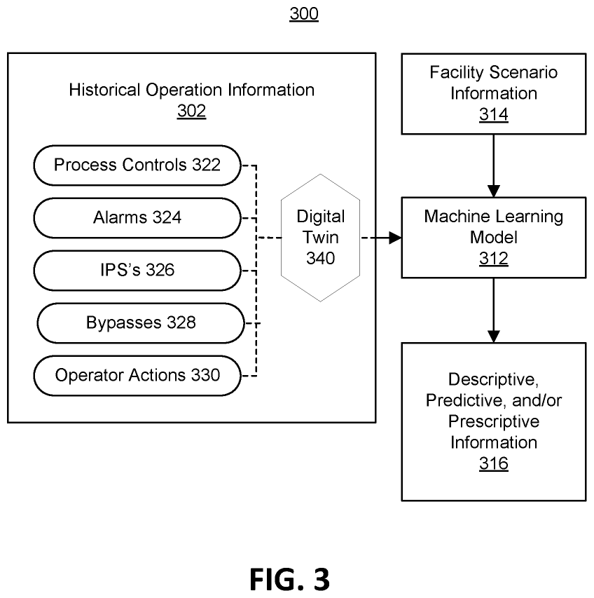

FIG. 3 illustrates an example process 300 for facilitating operations at a facility. In the process 300, historical operation information 302 for the facility may be used to train a machine learning model 312. The historical operation information 302 may include historical operation information from process controls 322, alarms 324, instrumented protective systems 326, bypasses 328, and/or operator actions 330. Different parts of the historical operation information 302 may be monitored, tracked, and/or stored separately. Different parts of the historical operation information 302 may not be correlated.

A digital twin 340 of the facility may be used to contextualize and correlate different parts of the historical operation information 302. Information from the process controls 322, the alarms 324, the instrumented protective systems 326, the bypasses 328, and/or the operator actions 330 may be contextualized and correlated by the digital twin 340 of the facility. The digital twin 340 may identify, extract, and package information relating to an event from the controls 322, the alarms 324, the instrumented protective systems 326, the bypasses 328, and/or the operator actions 330 for use in training a machine learning model 312. The machine learning model 312 may be trained using the historical operation information 302 provided by the digital twin to perform classification task and/or regression task.

The digital twin 340 may identify, extract, and package information relating to an event from the controls 322, the alarms 324, the instrumented protective systems 326, the bypasses 328, and/or the operator actions 330 based on relationships between components of the facility and/or the system(s) of record for the facility. The digital twin 340 may include the piping and instrumentation diagram (P&ID) information digitized in the form of equipment and instrumentation ontology map. The P&ID may include a diagram that shows the piping and process equipment together with the instrumentation (measuring instruments that are used for indicating, measuring, and recording physical quantities) and control devices. The P&ID may include a diagram which shows the interconnection of process equipment and the instrumentation used to control the process. The equipment ontology map may define which components are related to particular components and/or which components are related to particular events. The equipment ontology may provide information on strength of connection, interaction, dependency, and/or hierarchy between components of the facility. The equipment ontology map may be used to identify, extract, and package information relating to an event from the controls 322, the alarms 324, the instrumented protective systems 326, the bypasses 328, and/or the operator actions 330 for use in training the machine learning model 312.

The digital twin 340 may facilitate integration of information from separate monitoring systems to increase the efficiency of facility monitoring. The process 300 may facilitate operations at the facility, such as by reducing risk of facility shut-downs, improving equipment longevity, and/or expediting maintenance prioritization. The process 300 may, via use of the digital twin, digitize operator knowledge/experience by contextualizing operator actions, associate control loops, equipment, alarms, and bypass systems to reflect real-world relationships, enable identification of root causes of issues at the facility, and/or otherwise facilitate operations at the facility.

Facility scenario information 314 may be input into the machine learning model 312. The facility scenario information 314 may define a scenario of one or more operations at the facility. The machine learning model 312 output descriptive information, predictive information, and/or prescriptive information on the operation(s) at the facility. That is, the machine learning model 312 output descriptive information, predictive information, and/or prescriptive information on the scenario of operation(s) defined by the facility scenario information 314. Descriptive information on an operation may include information that describes the operation (e.g., the machine learning model 312 identifying operation(s) and/or event(s) that are occurring at the facility). Predictive information on an operation may include information that predicts what will happen at the facility (e.g., the machine learning model 312 predicting results of operation(s) at the facility—predicting event(s) that will occur following/as a result of the operation(s)). Prescriptive information on an operation may include information that recommends/requires what steps/actions should be taken at the facility (e.g., the machine learning model 312 recommending how the operation(s) at the facility should be changed, the machine learning model 312 being used to automate changes in operation(s) at the facility). Other usage of the machine learning model 312 to facilitate facility operations is contemplated.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate facility operations. The machine-readable instructions 100 may include one or more computer program components. The machine-readable instructions 100 may include a historical operation component 102, a train component 104, a storage component 106, a scenario component 108, a facility operation component 110, and/or other computer program components.

The historical operation component 102 may be configured to obtain historical operation information and/or other information for a facility. Historical operation information for a facility may include information on operations at the facility. Historical operation information for a facility may include information on operations that have occurred at the facility. Historical operation information for a facility may include time-series data relating to operations at the facility. Historical operation information for a facility may include a collection of measured, sensed, detected, and/or recorded characteristics of operations at the facility at different times. For example, historical operation information for a facility may include time-stamped information on event occurrences, sensor readings, operator actions, allowances, and/or bypass and safety actions.

Historical operation information for a facility may characterize operations that have occurred at the facility. Historical operation information may include information on operation characteristics at the facility. Operation characteristics of a facility may refer to characteristics of the facility (e.g., characteristics in and/or around the facility, characteristics of equipment at the facility) during an operation. Operation characteristics of a facility may refer to attribute, quality, configuration, parameter, and/or other characteristics of matter/equipment inside, within, and/or around the facility during an operation.

Historical operation information for a facility may characterize an operation at the facility by including information that defines, describes, delineates, identifies, is associated with, quantifies, reflects, sets forth, and/or otherwise characterizes values of attribute, quality, configuration, parameter, and/or other characteristics of matter/equipment inside, within, and/or around the facility during the operation. Historical operation information for a facility may characterize an operation at the facility by including information from which values of attribute, quality, configuration, parameter, and/or other characteristics of matter/equipment inside, within, and/or around the facility during the operation may be determined. Other types of historical operation information are contemplated.

Obtaining historical operation information may include one or more of accessing, acquiring, analyzing, determining, examining, generating, identifying, loading, locating, measuring, opening, receiving, retrieving, reviewing, selecting, storing, and/or otherwise obtaining the historical operation information. The historical operation component 102 may obtain historical operation information from one or more locations. For example, the historical operation component 102 may obtain historical operation information from a storage location, such as the electronic storage 13, electronic storage of a device accessible via a network, and/or other locations. The historical operation component 102 may obtain historical operation information from one or more hardware components (e.g., a computing device, a sensor) and/or one or more software components (e.g., software running on a computing device). The historical operation component 102 may obtain historical operation information from multiple databases/storage locations. For example, different types of historical operation information may be stored in different databases/storage locations, and parts of historical operation information that are relevant to particular event(s) may be obtained from different databases/storage locations.

The historical operation information for the facility may be obtained based on a digital twin of the facility and/or other information. A digital twin of a facility may refer to a virtual representation or a digital model of the facility. The digital twin may serve as a real-time digital counterpart of the facility and/or operations/processes that are occurring at the facility. The digital twin of the facility may define relationships between components of the facility. Components of the facility may refer to equipment in the facility, materials used in the facility, and/or other components of the facility. Relationships between components of a facility may include connection, interaction, dependency, hierarchy, and/or other relationships between the components. The relationships between the components of the facility may be used to obtain the historical operation information for the facility. The digital twin of the facility may define one or more systems of record for the facility. A system of record for the facility may refer to an information storage and retrieval system that is the authoritative source for data relating to the facility. A system of record for the facility may refer to a collection of and/or connections between related and/or contextualized information for the facility, such as design documents, equipment databases, timeseries data, inspection records, maintenance records, turnaround information, management of change, and/or other information for the facility. Information may be stored in different systems/databases, and the information stored in different systems/databases may be connected to each other through the digital twin. The information stored in different systems/databases may be accessed through the digital twin.

In some implementations, the historical operation information for the facility may include process control information, alarm information, bypass information, safety information, operator action information and/or other information. Process control information may refer to information from a process control system. Process control information may refer to information that defines and/or characterizes processes (e.g., operations, parts of operations) at the facility and/or control of processes at the facility. Alarm information may refer to information from an alarm management system. Alarm information may refer to information that defines and/or characterizes alarms that have been triggered at the facility and/or operation of alarms at the facility. Bypass information may refer to information from a bypass management system. Bypass information may refer to information that defines and/or characterizes bypasses at the facility (e.g., location of bypasses, equipment affected by bypasses, processes under bypasses). Safety information may refer to information from an instrumented protective system (IPS). Safety information may refer to information that defines and/or characterizes safety conditions, triggering/activation of safety conditions, and/or operation of SIS equipment. Operator action information may refer to information on operation actions at the facility. Operator action information may refer to information that defines and/or characterizes actions taken by one or more operators at the facility.

The process control information, the alarm information, the bypass information, the safety information, the operator action information, and/or other information related to an event may be correlated for training of one or more machine learning models by the digital twin. Correlation of different information may include establishing/determining relationship between the different information. An event may refer to an occurrence of one or more things. An event may refer to one or more changes at the facility. For example, an event may include a change in process conditions, such as change in pressure, temperature, and/or flowrate, startup/shutdown of a piece of equipment, triggering of alarms, operator actions, change in operation, and/or other changes at the facility. Information correlated to an event may be used to train a machine learning model. Digital twin may be used to determine what information is relevant to an event and what information is not relevant to an event.

For example, the digital twin may be used to identify, extract, and/or package parts of the historical operation information for an event based on the relationship between the components of the facility and/or the system(s) of records for the facility. The digital twin may include an equipment ontology map defining which components are related to particular components and/or which components are related to particular events. The equipment ontology map may be used to determine what information is relevant to an event, and the relevant information for the event may be used as the historical operation information for the facility to train a machine learning model.

In some implementations, the process control information, the alarm information, the bypass information, the safety information, the operator action information, and/or other information related to the event may be correlated based on a piping and instrumentation diagram, a cause and effect chart, and/or other information. The piping and instrumentation diagram and the cause and effect chart may be used to build relationships between different types of information. For example, interconnection of process equipment and the instrumentation used to control process in the piping and instrumentation diagram may be used to correlate different information to an event. The cause and effect chart may define specific sequential relationships between components, such as how equipment may be affected/changed based on occurrence of a particular event (e.g., what components can be activated responsive to an alarm to shut down equipment/facility), and the sequential relationships between the components may be used to correlate different information to an event.

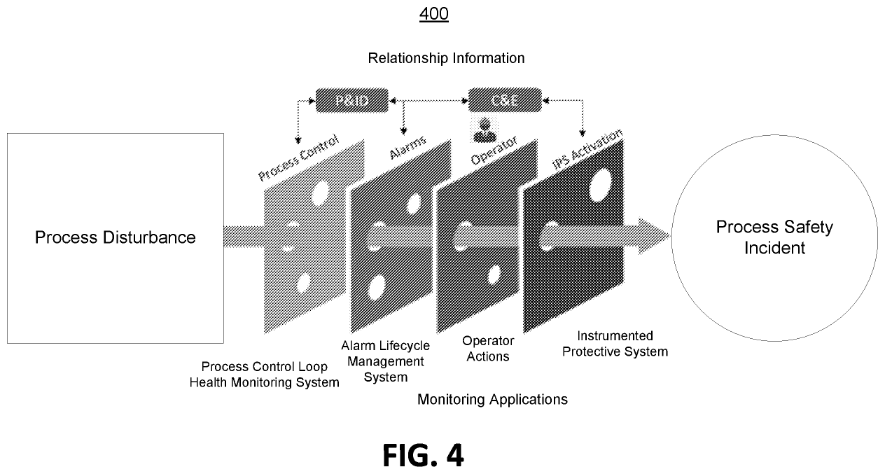

FIG. 4 illustrates an example Instrumented protection layers and Operator action overview 400. As shown in the overview 400, relationships between information from different monitoring systems may be established using the piping and instrumentation diagram (P&ID) and the cause and effect chart (C&E). Between a process disturbance (e.g., unwanted operating condition such as pressure spike, equipment malfunction) and process safety incident, different monitoring applications may exist: (1) automated process control to help regulate and stabilize the process; (2) alarms to alert operators, (3) operator actions manage the process disturbance and return the facility to normal operation, and (4) instrumented protective system activation to shut down the facility if safety condition is breached. Relationships between information from process control and alarms may be established (e.g., relate alarms to process control loop performance) using the piping and instrumentation diagram, while relationships between information from alarms and instrumented protective system may be established using the cause and effect chart. Other information (e.g., inspection records, design documents) may be used to establish relationship between information from different monitoring systems.

In some implementations, the digital twin may output the historical operation information for the facility based on the relationship between the components of the facility, the system(s) of record for the facility, and/or other information. The digital twin itself may determine which parts of the historical operation information are relevant to an event, and those relevant parts of the historical operation information may be output by the digital twin for use in training a machine learning model.

In some implementations, correlation of different parts of the historical operation information for the facility (e.g., the process control information, the alarm information, the bypass information, the safety information, the operator action information, and/or other information) related to a particular event being performed based on the piping and instrumentation diagram may include (1) generation of a graph model for the facility based on the piping and instrumentation diagram and/or other information, and (2) the correlation of the different parts of the historical operation information for the facility related to the particular event being performed based on the graph model for the facility and/or other information. That is, to determine whether different parts of the historical operation information are related to a particular event (e.g., for training of a machine learning model), a graph model for the facility may be generated, and the graph model may be used to determine different parts of the historical operation information that are related to the particular event.

A graph model may refer to a model that represents components of a facility using nodes and connections between the components using edges between the nodes. A graph model for the facility may be generated based on a piping and instrumentation diagram for the facility and/or other information. For example, a piping and instrumentation diagram for the facility may be converted into a graph model for the facility. For instance, the piping and instrumentation diagram for the facility may be scanned and component blocks of the piping and instrumentation diagram may be converted into nodes and lines between the component blocks may be converted into edges. Other generations of graph models are contemplated.

The graph model for the facility may include nodes for physical components of the facility, control components of the facility, and/or other components of the facility. The graph model may include different types of nodes for different types of components of the facility. Physical components of the facility may refer to parts, equipment, and/or other components of the facility that operate and/or are operated on to process, contain, move, and/or otherwise interact with materials at the facility. Physical components of the facility may refer to parts, equipment, and/or other components of the facility that receive signals from control components of the facility and operate in accordance with the received signals (e.g., commands conveyed by the received signals). For example, physical components of a fluid facility may include pumps, actuators, motors, valves, doors, and/or other physical components that can control flow of fluid.

Control components of the facility may refer to parts, equipment, and/or other components of the facility that operate and/or are operated on to control operation of physical components of the facility. Control components of the facility may refer to parts, equipment, and/or other components of the facility that transmit signals to physical components of the facility and control the operations of the physical components of the facility. Control components of the facility may refer to parts, equipment, and/or other components of the facility that receive signals from sensors of the facility to monitor operation of the physical components of the facility. For example, control components of a fluid facility may include logical blocks that take sensor measurements for the facility and, responsive to deviation of fluid flow in the facility from normal operating conditions, send signals to pumps, actuator, and/or motors to control the flow of fluid in the facility.

The facility may include separate and independent control components to maintain safe operations at the facility. For example, the facility may include a distributed control system and an instrumented protective system that operate independently of each other to restore deviations in facility operations and shut down operations when necessary. Different types of control components may be represented by the same or different types of nodes within the graph model.

The graph model for the facility may include different types of edges between nodes to represent different connections between the corresponding components of the facility. Connections between the components of the facility may include physical connections, logical connections, and/or other connections. Physical connections may be represented by one type of edge while logical connections may be represented by another type of edge.

Physical connections between components of the facility may refer to connections that convey physical materials between different components of the facility. For example, physical connections between components of a fluid facility may include one or more process lines between the components of the fluid facility. A process line may include interconnected piping components, such as tubing, pipes, pressure hoses, valves, separators, traps, flanges, fittings, gaskets, strainers, and/or other components. Physical connections between components of the facility may refer to connections that physically links the components of the facility. For example, physical connections between components of a fluid facility may include physical link between an actuator and a valve in the facility.

Logical connections between components of the facility may refer to connections that logically links the components of the facility. Logical connections between components of the facility may refer to connections that convey information between different components of the facility. For example, local connections between components of a fluid facility may include one or more electrical connections (e.g., conveying sensor signals, conveying command signals, conveying information signals) and/or one or more input/output connections (e.g., facilitating communication) between components of the facility.

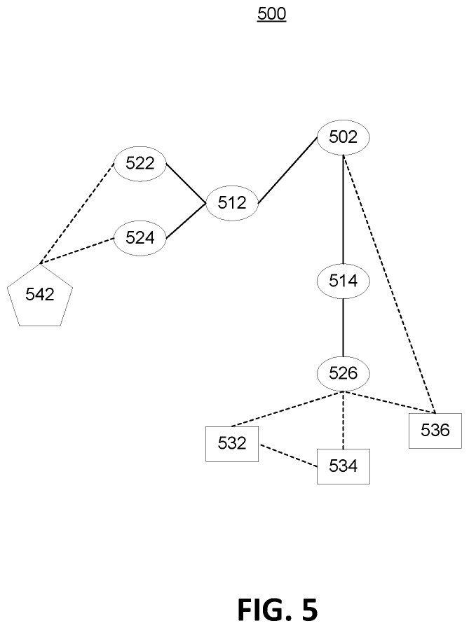

FIG. 5 illustrates an example graph model 500 for a facility. The graph model 500 may show a part of a larger graph model for the facility. The graph model 500 may include nodes 502, 512, 514, 522, 524, 526, for physical components of the facility and nodes 532, 534, 536, 542 for control components of the facility. Solid edges between the nodes of the graph model 500 may represent physical connections between the corresponding components. Dashed edges between the nodes of the graph model 500 may represent logical connections between the corresponding components. For example, the node 502 may represent a heat exchanger, the node 514 may represent a valve of the heat exchanger, and the node 526 may represent an actuator for the valve. The nodes 532, 534, 536 may represent control systems/blocks that can control the actuator (by sending signals to the actuator) to operate the valve. The control systems/blocks represented by the nodes 532, 534 may communicate with each other. The control system/block represented by the node 536 may send signals to and/or receive signals from the heat exchanger represented by the node 502. The control systems/blocks represented by the nodes 532, 534, 536 may be part of distributed control system for the facility to keep the heat exchanger and other components of the facility in operation.

The facility may include an instrumented protective system represented by the node 542. The instrumented protective system may operate independently of the distributed control system to prevent the facility from operating in dangerous condition. For example, if the distributed control system fails to bring deviations in operations back to normal operation conditions (e.g., operation getting close to or beyond safety limits), the instrumented protective system may shut down the operations at the facility. The instrumented protective system may provide automated shut-down response at the facility for safety violations.

In some implementations, different types of physical connections and/or different types of logical connections may be represented by different types of edges. For example, logical connections with an instrumented protective system may be represented by one type of edge while logical connections with a distributed control system may be represented by another type of edge.

Historical operation information for a facility may include vast amounts of data on operations being performed at the facility. For example, historical operation information may include information on actions taken by multiple operators at the facility. When an event occurs at the facility, actions may be taken by one or more operators to address the event and actions may be taken by one or more operators unrelated to the event. For example, when an alarm is triggered, one or more operators may take actions to address the alarm while one or more other operators may take actions unrelated to the alarm. To use the historical operation information for machine learning training, information relating to the event may need to be correlated. That is, different parts of the historical information that are related to each other may need to be correlated for use in training machine learning models.

The graph model may be used to correlate information that are related to an event (e.g., change in operation parameters, alarm being triggered). The historical operation information for the facility may be filtered using time to identify information that may be related to the event. For example, the historical operation information may be filtered to identify information for actions that were taken after an alarm is triggered and before the alarm (e.g., excursion/deviations in operation) is resolved. Such filtering may identify historical operation information that may be temporally related to the event.

After temporal filtering, the graph model may be used to identify historical operation information that is related to the event. The event may be associated with a particular node, and historical operation information related to components of the facility that are a certain distance (e.g., hops) away from the node associated with the event may be identified as being related to the event. For example, referring to FIG. 5, an alarm may be triggered by the component (e.g., control system/block, sensor) represented by the node 536. Nodes that are within a threshold distance from the node 536 may be identified and the historical operation information for actions taken at the corresponding components may be identified as being related to the alarm. Such identification of historical operation information may be used to generate a repository of actions taken for different events at the facility. Actions taken by one operator or multiple operators may be correlated with specific events at the facility.

In some implementations, different types of edges between the nodes of the graph model may be treated the same for distance (e.g., hop) calculation. For example, whether the edge being traversed represents a physical connection or a logical connection may not matter in determining the distance that is traversed. In some implementations, different types of edges between the nodes of the graph model may be treated differently for distance calculation. For example, traversal of an edge representing a physical connection may be weighed more or less than traversal of an edge representing a logical connection. As another example, traversal of an edge representing a physical connection or a logical connection of a certain type may be weighed more or less than traversal of an edge representing a physical connection or a logical connection of other types. For instance, traversal of an edge representing a logical connection with an instrumented protective system may be weighed more or less than traversal of an edge representing a logical connection with a distributed control system. In some implementations, weights of edges may be customized. For example, an edge representing a particular connection may be assigned a weight different from other edges.

The outcome of actions taken at the facility may be analyzed and correlated to particular actions taken at the facility. For example, for individual and/or combination of actions taken for a particular type of event, the result of the action(s) may be correlated with the action(s). The results among different actions/combinations of actions may be compared to determine which actions should be suggested/recommended to operators and/or which actions should be automatically performed. For example, time taken by the actions to resolve the excursion/deviations in operation and the magnitude of change in operation parameters by the actions may be used to rank the action(s). For instance, how quickly the actions resolved the excursion/deviations in operation and the impact of the actions on operation of the facility (e.g., the amount by which the action(s) changed temperature, flowrate, pressure, etc.) may be used to rank action(s) based on the outcome. Correlation between actions taken at the facility and the outcome of the actions may be used to train one or more machine learning models, and the machine learning model(s) may be used to suggest/recommend or automate operator actions based on events occurring at the facility.

The train component 104 may be configured to train one or more machine learning models. The machine learning model(s) may be trained using the historical operation information for the facility and/or other information. The machine learning model may be trained to perform classification task and/or regression task. That is, the trained machine learning model may perform one or more classification tasks or one or more regression tasks to generate the output. The trained machine learning model(s) may facilitate one or more operations at the facility. The trained machine learning model(s) may facilitate operation(s) at the facility by outputting descriptive information, predictive information, prescriptive information, and/or other information on the operation(s) at the facility. Descriptive information may include information on what is happening at the facility (e.g., identification of operations/events occurring at the facility). Predictive information may include information on what will happen at the facility (e.g., prediction of events that will occur at the facility). Prescriptive information may include information on what steps/actions should be taken at the facility (e.g., recommendation on how the operation(s) should be changed by an operator, automatically changing operation(s) at the facility to prevent shutdown of the facility).

Training a machine learning model may include facilitating learning by the machine learning model by processing examples through the machine learning model. Pairings of historical operation information and information on desired output type may be provided to the machine learning model as examples of input and desired results, respectively. The historical operation information may be used as the type of input to be received by the trained machine learning model and the information on the desired output type paired to the historical operation information may be used as the type of output to be generated by the machine learning model.

For example, to train a machine learning model to output descriptive information, historical operation information related to an operation/event may be paired with identification/description of the operation/event for training the machine learning model. Historical operation information related to an operation/event may be paired with identification/description of what is happening at the facility to train the machine learning model. Processing such pairing of information through the machine learning model may enable the machine learning model to learn patterns in historical operation information that are correlated with particular operations/events at the facility.

To train a machine learning model to output predictive information, historical operation information related to an operation/event may be paired with identification/description of an event that occurs later at the facility. Historical operation information related to an operation/event may be paired with identification/description of what will happen at the facility to train the machine learning model. Processing such pairing of information through the machine learning model may enable the machine learning model to learn patterns in historical operation information that are correlated with particular future events at the facility.

To train a machine learning model to output prescriptive information, historical operation information related to an operation/event may be paired with identification/description of steps/actions to be taken at the facility (e.g., by an operator, automatically). Historical operation information related to an operation/event may be paired with identification/description of steps/actions to be taken at the facility to train the machine learning model. Processing such pairing of information through the machine learning model may enable the machine learning model to learn patterns in historical operation information that are correlated with particular steps/actions to be taken at the facility.

In some implementations, pairing of historical operation information with specific steps/actions to be taken at the facility may digitize historical actions by operators. For example, operator actions to different operations/events, along with the results of the actions, may be recorded. Historical operation information may be paired with specific steps/actions based on the desired outcome. That is, the outcome of prior operator actions may be used to guide how the machine learning model is trained. Historical operation information may be paired with outcome of prior operator actions to enable the machine learning model to provide likely outcome of steps/actions that are output by the machine learning model. For example, in addition to recommending particular steps/actions be taken by an operator of the facility, the machine learning model may output probabilit(ies) of outcome from the operator taking the recommended steps/actions. The machine learning model may output multiple steps/actions that can be taken by the operator, along with likely outcome of different steps/actions.

In some implementations, the machine learning model(s) may include one or more sequence models. A sequence model may refer to a machine learning model that receives as input and/or outputs sequences of data. For example, a sequence model may refer to a machine learning model that receives as input and/or outputs time-series data. For instance, the machine learning model(s) may include a Markov model. Use of other types of machine learning models is contemplated.

The storage component 106 may be configured to store the trained machine learning model(s). The trained machine learning model(s) may be stored in one or more non-transient storage media and/or other storage media. For example, the storage component 106 may store the trained machine learning model(s)/information defining the trained machine learning model(s) in a storage location, such as the electronic storage 13, electronic storage of a device accessible via a network, and/or other locations. The trained machine learning model(s) may be stored for use in facilitating operations at the facility. The trained machine learning model(s) may be stored for use in (1) identifying what is happening at the facility (e.g., output descriptive information that identifies operation/events happening at the facility), (2) predicting what will happen at the facility (e.g., output predictive information that identifies events that will happen at the facility), and/or (3) recommending/guiding what actions should be taken at the facility (e.g., output prescriptive information that recommends particular actions be taken by an operator; output prescriptive information that controls how automated operations are controlled at the facility). The trained machine learning model(s) may be stored for retrieval/running when facilitating operations at the facility.

The scenario component 108 may be configured to obtain facility scenario information and/or other information. The facility scenario information may define a scenario of one or more operations at the facility. A scenario of operation(s) at the facility may refer to an instance in which one or more operations are taking place at the facility. A scenario of operation(s) may cover a moment in time or a duration of time. A scenario of operation(s) may include occurrence of one or more events during the operation(s). The facility scenario information may define a scenario of operation(s) at the facility by including information that defines one or more content, qualities, attributes, features, and/or other aspects of the scenario of operation(s) at the facility.

For example, facility scenario information may define a scenario of operation(s) at the facility by including information that characterizes that operation(s) being conducted at the facility. Facility scenario information may include information on operation characteristics at the facility at a particular time (a moment in time, a duration of time). Facility scenario information may include real-time facility scenario information. Real-time facility scenario information may refer to facility scenario information that defines current operation(s) at the facility. For example, real-time facility scenario information may characterize operation characteristics of the facility currently being reported by one or more sensors and/or operation characteristics of the facility that has been measured within a threshold amount of time (e.g., operation characteristics measured within the past minute/hour/day). Facility scenario information for a facility may include the same type of information as the historical operation information for the facility. Other types of facility scenario information are contemplated.

Obtaining facility scenario information may include one or more of accessing, acquiring, analyzing, determining, examining, generating, identifying, loading, locating, measuring, opening, receiving, retrieving, reviewing, selecting, storing, and/or otherwise obtaining the facility scenario information. The scenario component 108 may obtain facility scenario information from one or more locations. For example, the scenario component 108 may obtain facility scenario information from a storage location, such as the electronic storage 13, electronic storage of a device accessible via a network, and/or other locations. The scenario component 108 may obtain facility scenario information from one or more hardware components (e.g., a computing device, a sensor) and/or one or more software components (e.g., software running on a computing device). The scenario component 108 may obtain facility scenario information from multiple databases/storage locations. For example, different types of facility scenario information may be stored in different databases/storage locations, and parts of facility scenario information that are relevant to particular event(s)/scenario(s) may be obtained from different databases/storage locations. The digital twin of the facility may be used to obtain relevant parts of information from different monitoring systems as the facility scenario information.

The facility operation component 110 may be configured to input the facility scenario information and/or other information into the trained machine learning model(s). The trained machine learning model(s) may use the facility scenario information to generate output. The trained machine learning model(s) may output descriptive information, predictive information, and/or prescriptive information, and/or other information on the operation(s) (on the scenario of operation(s)) at the facility.

For example, a trained machine learning model may output descriptive information on the operation(s) at the facility by outputting information that describes the operation(s), event(s), and/or other conditions at the facility. For instance, based on the facility scenario information input into the trained machine learning model, the trained machine learning model may output that a column flooding is occurring/has occurred at the facility. The trained machine learning model may output details about the column flooding, such as location and/or timing of the column flooding, facility components/equipment affected by the column flooding, and/or the source/root cause of the column flooding.

A trained machine learning model may output predictive information on the operation(s) at the facility by outputting information that predicts what will happen at the facility. For instance, based on the facility scenario information input into the trained machine learning model, the trained machine learning model may output its prediction on time to failure of facility components/equipment due to the column flooding. The trained machine learning model may output details about the prediction, such as which components/equipment will fail, the predicted timing of failure, and/or the predicted extent of failure.

A trained machine learning model may output prescriptive information on the operation(s) at the facility by outputting information that details what steps/actions should be taken at the facility. For instance, based on the facility scenario information (e.g., pump trip) input into the trained machine learning model, the trained machine learning model may output optimal steps/actions that should be taken by one or more operators to prevent further disruption at the facility and restore the facility to normal operating condition. In some implementations, one or more automated operations at the facility may be performed based on the prescriptive information on the operation(s) at the facility and/or other information. That is, rather than outputting the prescriptive information to operators to guide their actions in restoring normal operations at the facility, operations at the facility may be automated changed in accordance with the prescriptive information.

In some implementations, inputs and outputs of multiple trained machine learning models may be chained together. For example, facility scenario information may be input into a machine learning model trained to output descriptive information and/or predictive information. The descriptive information and/or predictive information output by the trained machine learning model may be used as facility scenario information that is input into a machine learning model trained to output prescriptive information. The machine learning model trained to output prescriptive information may utilize the information output by other machine learning model(s) to prescribe what steps/actions should be taken at the facility.

In some implementations, the facility operation component 110 may be configured to provide visualization of descriptive information, predictive information, and/or prescriptive information on the operation(s) (on the scenario of operation(s)) at the facility. Visualization of descriptive information, predictive information, and/or prescriptive information may include visual/graphical representation of the descriptive information, the predictive information, and/or the prescriptive information. Visualization of descriptive information, predictive information, and/or prescriptive information may be provided on the display 14 (e.g., to one or more operators, within one or more graphical user interfaces). For example, descriptive information, predictive information, and/or prescriptive information may be modeled in three-dimensional space along with a three-dimensional modeling of the facility to visualize what is happening at the facility, what is predicted to happen at the facility, and/or what steps/actions should be performed at the facility. Use of other visualization is contemplated.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

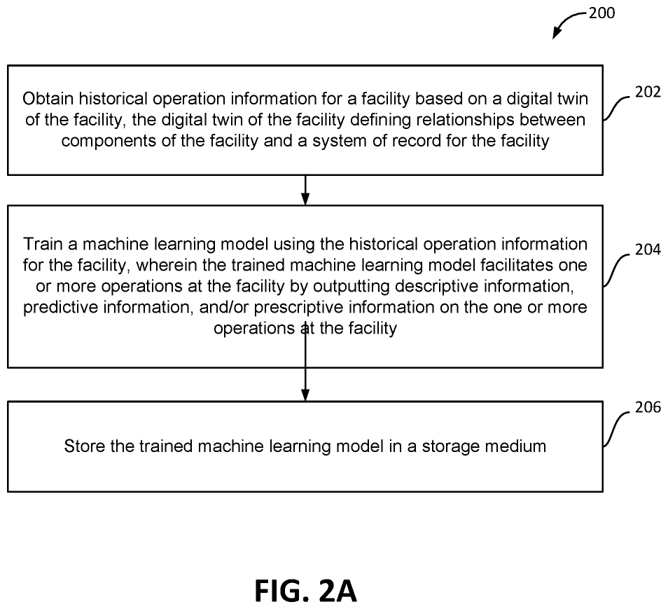

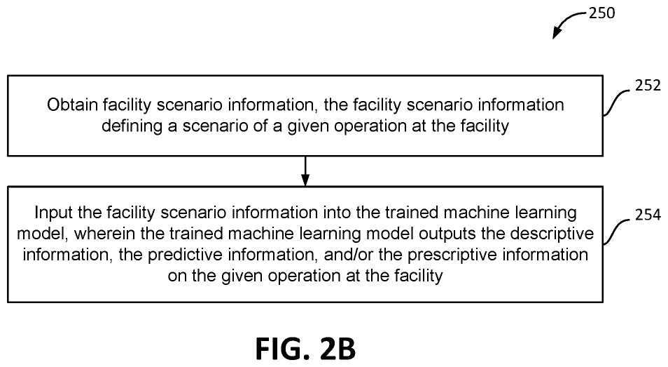

FIGS. 2A and 2B illustrate methods 200, 250 for facilitating facility operations. The operations of methods 200, 250 presented below are intended to be illustrative. In some implementations, methods 200, 250 may be accomplished with one or more additional operations not described, and/or without one or more of the operations discussed. In some implementations, two or more of the operations may occur substantially simultaneously.

In some implementations, methods 200, 250 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2A and method 200, at operation 202, historical operation information and/or other information for a facility may be obtained. The historical operation information for the facility may be obtained based on a digital twin of the facility and/or other information. The digital twin of the facility may define relationships between components of the facility and a system of record for the facility. In some implementations, operation 202 may be performed by a processor component the same as or similar to the historical operation component 102 (Shown in FIG. 1 and described herein).

At operation 204, a machine learning model may be trained using the historical operation information and/or other information for the facility. The trained machine learning model may facilitate one or more operations at the facility by outputting descriptive information, predictive information, prescriptive information, and/or other information on the operation(s) at the facility. In some implementations, operation 204 may be performed by a processor component the same as or similar to the train component 104 (Shown in FIG. 1 and described herein).

At operation 206, the trained machine learning model may be stored in a storage medium. In some implementations, operation 206 may be performed by a processor component the same as or similar to the storage component 106 (Shown in FIG. 1 and described herein).

Referring to FIG. 2B and method 250, at operation 252, facility scenario information and/or other information may be obtained. The facility scenario information may define a scenario of a given operation at the facility. In some implementations, operation 252 may be performed by a processor component the same as or similar to the scenario component 108 (Shown in FIG. 1 and described herein).

At operation 254, the facility scenario information may be input into the trained machine learning model. The trained machine learning model may output the descriptive information, the predictive information, the prescriptive information, and/or other information on the given operation at the facility. In some implementations, operation 254 may be performed by a processor component the same as or similar to the facility operation component 110 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A computer-implemented method of determining wellbore pressures and multiphase fluid flow rates, the method comprising:
obtaining an average temperature of a multiphase fluid in a section of a wellbore;
obtaining an average speed of sound in the multiphase fluid in the section of the wellbore;
calculating phase mass flow rates of the multiphase fluid through the section at least based on the average temperature, the average speed of sound, an estimated pressure at an estimated-pressure location in the wellbore, and a difference between a known pressure and the estimated pressure; and
calculating a total mass flow rate of the multiphase fluid through the section based on the phase mass flow rates of the multiphase fluid, wherein the calculating the phase mass flow rates of the multiphase fluid through the section and the calculating the total mass flow rate of the multiphase fluid through the section comprise iteratively calculating the phase mass flow rates of the multiphase fluid and the total mass flow rate of the multiphase fluid by adjusting the estimated pressure until the total mass flow rate is within a threshold value of a known total mass flow rate of the multiphase fluid.

2. The computer-implemented method of claim 1, further comprising calculating phase mass flow rates of the multiphase fluid through a second section of the wellbore at least based on an average temperature in the second section, an average speed of sound in the second section, the estimated pressure, and a difference between a second known pressure at a second known-pressure location in the wellbore and the estimated pressure, wherein the second section is adjacent to the section and includes at least one producing zone of the wellbore.

3. The computer-implemented method of claim 2, wherein the calculating phase mass flow rates of the multiphase fluid through the second section is performed at each iteration of calculating the phase mass flow rates of the multiphase fluid through the section and the total mass flow rate of the multiphase fluid through the section.

4. The computer-implemented method of claim 2, wherein the second known pressure is a bottom hole pressure of the wellbore.

5. The computer-implemented method of claim 2, wherein the second section is above at least one other producing zone of the wellbore.

6. The computer-implemented method of claim 2, further comprising determining a zonal inflow in the section by performing a mass balance calculation based on the phase mass flow rates of the multiphase fluid through the section and the phase mass flow rates of the multiphase fluid through the second section of the wellbore.

7. The computer-implemented method of claim 6, wherein determining the zonal inflow in the section comprises performing a flash calculation based on the phase mass flow rates of the multiphase fluid through the second section at average conditions in the section.

8. The computer-implemented method of claim 2, further comprising determining a zonal inflow in the second section by performing a mass balance calculation based on the phase mass flow rates of the multiphase fluid through the second section and phase mass flow rates of the multiphase fluid through a third section of the wellbore, wherein the third section is below the second section and includes at least one other producing zone.

9. The computer-implemented method of claim 1, wherein the section of the wellbore is an entirety of the wellbore and the estimated pressure is a bottom hole pressure of the wellbore.

10. The computer-implemented method of claim 1, further comprising calculating phase mass flow rates of the multiphase fluid through a second section at least based on an average temperature in the second section, an average speed of sound in the second section, a second estimated pressure at a second estimated-pressure location in the wellbore that is different from the estimated-pressure location, and a difference between the known pressure and the second estimated pressure; and
calculating a total mass flow rate of the multiphase fluid through the second section based on the phase mass flow rates of the multiphase fluid through the second section, wherein the phase mass flow rates of the multiphase fluid through the second section and the total mass flow rate of the multiphase fluid through the second section are calculated iteratively by adjusting the second estimated pressure until the total mass flow rate through the second section is within a second threshold value of the known total mass flow rate of the multiphase fluid.

11. A system for determining wellbore pressures and multiphase fluid flow rates, the system comprising:
a temperature sensor configured to measure temperature for use in determining an average temperature of a multiphase fluid in a section of a wellbore;
an acoustic sensor configured to measure sound for use in determining an average speed of sound in the multiphase fluid in the section of the wellbore; and
a computing device configured to:
calculate phase mass flow rates of the multiphase fluid through the section at least based on the average temperature, the average speed of sound, an estimated pressure at an estimated-pressure location in the wellbore, and a difference between a known pressure and the estimated pressure; and
calculate a total mass flow rate of the multiphase fluid through the section based on the phase mass flow rates of the multiphase fluid, wherein the computing device is configured to calculate the phase mass flow rates of the multiphase fluid and the total mass flow rate of the multiphase fluid by iteratively calculating the phase mass flow rates of the multiphase fluid and the total mass flow rate of the multiphase fluid by adjusting the estimated pressure until the total mass flow rate is within a threshold value of a known total mass flow rate of the multiphase fluid.

12. The system of claim 11, wherein the computing device is further configured to calculate phase mass flow rates of the multiphase fluid through a second section of the wellbore at least based on an average temperature in the second section, an average speed of sound in the second section, the estimated pressure, and a difference between a second known pressure at a second known-pressure location in the wellbore and the estimated pressure, wherein the second section is below the section and includes at least one producing zone of the wellbore.

13. The system of claim 12, wherein the computing device is further configured to calculate the phase mass flow rates of the multiphase fluid through the second section at each iteration of calculating the phase mass flow rates of the multiphase fluid through the section and the total mass flow rate of the multiphase fluid through the section.

14. The system of claim 12, wherein the second known pressure is a bottom hole pressure of the wellbore.

15. The system of claim 12, wherein the second section is above at least one other producing zone of the wellbore.

16. The system of claim 12, wherein the computing device is further configured to determine a zonal inflow in the section by performing a mass balance calculation based on the phase mass flow rates of the multiphase fluid through the section and the phase mass flow rates of the multiphase fluid through the second section of the wellbore.

17. The system of claim 16, wherein determining the zonal inflow in the section comprises performing a flash calculation based on the phase mass flow rates of the multiphase fluid through the second section at average conditions in the section.

18. The system of claim 12, wherein the computing device is further configured to determine a zonal inflow in the second section by performing a mass balance calculation based on the phase mass flow rates of the multiphase fluid through the second section and phase mass flow rates of the multiphase fluid through a third section of the wellbore, wherein the third section is below the second section and includes at least one other producing zone.

19. The system of claim 11, wherein the section of the wellbore is an entirety of the wellbore and the estimated pressure is a bottom hole pressure of the wellbore.

20. The system of claim 11, wherein the computing device is further configured to:
calculate phase mass flow rates of the multiphase fluid through a second section at least based on an average temperature in the second section, an average speed of sound in the second section, a second estimated pressure at a second estimated-pressure location in the wellbore that is different from the estimated-pressure location, and a difference between the known pressure and the second estimated pressure; and
calculate a total mass flow rate of the multiphase fluid through the second section based on the phase mass flow rates of the multiphase fluid through the second section, wherein the phase mass flow rates of the multiphase fluid through the second section and the total mass flow rate of the multiphase fluid through the second section are calculated iteratively by adjusting the second estimated pressure until the total mass flow rate through the second section is within a second threshold value of the known total mass flow rate of the multiphase fluid.
